(19) United States
(12) Patent Application Publication
(10) Pub. No.: US 2025/0029207 A1
(43) Pub. Date: Jan. 23, 2025

(54) UPSAMPLING A DIGITAL MATERIAL MODEL BASED ON RADIANCES

(71) Applicant: Adobe Inc., San Jose, CA (US)

(72) Inventors: Jean Marc Christian Marie Thiery, Paris (FR); Tamy Boubekeur, Paris (FR); Robin Faury, Clermont-Ferrand (FR); Jérémy Nicolas Levallois, Lyon (FR); Alban Elias Gauthier, Salans (FR)

(73) Assignee: Adobe Inc., San Jose, CA (US)

(21) Appl. No.: 18/355,952

(22) Filed: Jul. 20, 2023

(51) Int. Cl. G06T 3/40; G06T 15/04; G06T 15/50

(52) U.S. Cl. CPC G06T 3/4053; G06T 15/04; G06T 15/50

(57) ABSTRACT

In implementation of techniques for upsampling a digital material model based on radiances, a computing device implements an upsampling system to receive an input digital material model having a first resolution. The upsampling system generates a bilinearly upsampled texel based on the input digital material model having the first resolution. The upsampling system then generates a texel having a second resolution that is higher than the first resolution based on the bilinearly upsampled texel using a machine learning model trained on training data to generate texels. Based on the texel having the second resolution, the upsampling system generates an output digital material model having a resolution that is higher than the first resolution.

### BACKGROUND

In computer graphics, a material is described by a collection of maps, which are two-dimensional (2D) images used to model visual details for virtual three-dimensional (3D) objects. For example, a material is applied to a surface of a virtual 3D object to simulate an appearance of different physical materials, including wood, metal, fabric, or stone. Digital material models tailor spatially-varying properties of the material in a virtual environment and are created using image editing applications and are then applied to the virtual 3D object within a 3D rendering or game engine. Different digital material models are combined, resulting in a visual illusion of complex materials without modeling every small detail. However, conventional techniques used to generate digital material models often cause errors and result in visual inaccuracies and computational inefficiencies in real world scenarios.

### SUMMARY

Techniques and systems for upsampling a digital material model based on radiances are described. In an example, an upsampling system receives an input digital material model having a first resolution. In some examples, the input digital material model having the first resolution includes a base color map, a normal map, a metallic map, a roughness map, and a height map. Based on the input digital material model having a first resolution, the upsampling system generates a bilinearly upsampled texel.

The upsampling system also generates a texel having a second resolution that is higher than the first resolution based on the bilinearly upsampled texel using a machine learning model trained on training data to generate texels. For example, the training data includes renderings computed from texels upsampled from an image upsampler at different light positions.

The upsampling system then generates an output digital material model based on the texel having the second resolution, the output digital material model having a resolution that is higher than the first resolution. The high resolution digital material model is then output for display in a user interface. In some examples, the output digital material model is applied to a three-dimensional geometry.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ techniques and systems for upsampling a digital material model based on radiances as described herein.

FIG. 2 depicts a system in an example implementation showing operation of an upsampling module for upsampling a digital material model based on radiances.

FIG. 3 depicts an example of an input digital material model.

FIG. 4 depicts an example of an architecture of the upsampling module.

FIG. 5 depicts an example including a table of outputs including different high resolution digital material models.

FIG. 6 depicts a procedure in an example implementation of upsampling a digital material model based on radiances.

FIG. 7 depicts a procedure in an additional example implementation of upsampling a digital material model based on radiances.

FIG. 8 illustrates an example system including various components of an example device that can be implemented as any type of computing device as described and/or utilized with reference to FIGS. 1-7 to implement embodiments of the techniques described herein.

### DETAILED DESCRIPTION

### Overview

A digital material model is made of multiple two-dimensional (2D) image maps used to define an appearance of a three-dimensional (3D) object in a virtual environment. The digital material model is applied to a surface of the 3D model to provide details that simulate a surface of real-world material textures, including wood, metal, fabric, stone, or other materials on the 3D object. In this example, the digital material model is a compilation of maps specifying base color, normal properties, metallicness, roughness, and height that drive a standard microfacet reflectance model.

A digital material model is applied to the 3D object by mapping pixels of the 2D image onto the surface of the 3D object by assigning coordinates to vertices of the 3D object that determine how the digital material model wraps around the 3D object's surface. Because the digital material model is a low resolution sample of a material, applying the digital material model to the 3D object involves upsampling the digital material model. Upsampling the digital material model increases resolution of the digital material model.

Conventional techniques used to upsample digital material models employ bilinear upsampling. Bilinear upsampling estimates values of new pixels by considering the surrounding pixels in a 2×2 neighborhood. For example, each pixel in the original image is replaced by a 2×2 grid of new pixels, resulting in an image with twice the width and height. The values of the new pixels are determined by averaging the values of the nearest four pixels from the original image. Bilinear upsampling increases resolution, which measures a number of total pixels, but does not increase definition, which measures a number of pixels per square unit of measurement.

However, conventional bilinear upsampling does not account for accurate exposure of the digital material model to different radiances, which are based on exposure of the digital material model to different virtual lighting environments. As a result, a bilinearly upsampled digital material model using conventional techniques does not behave realistically when exposed to a variety of light sources and lighting directions in the virtual environment, revealing a low resolution nature of the original material. For example, a digital material model featuring a virtual texture representing ceramic tile appears blurry with respect to gloss, shadows, and highlights from different light directions after the digital material model is bilinearly upsampled.

Techniques and systems are described for upsampling a digital material model based on radiances that address the technical challenges of conventional upsampling techniques. An upsampling system begins in this example by receiving an input digital material model, which includes, but is not limited to, a base color map, a normal map, a metallic map, a roughness map, and a height map.

The upsampling system then renders and upsamples multiple images representing different radiances of the input digital material model. A radiance corresponds to a response of a material under a specific light position relative to the input digital material model. The upsampling system then generates a super-resolution digital material model based on each image of the multiple upsampled images representing the different radiances of the input digital material model using an RGB upsampler. A machine learning model is then trained on a collection of material examples coupled with the super-resolution digital material model.

The upsampling system also generates a bilinearly upsampled digital material model that includes bilinearly upsampled versions of the base color map, the normal map, the metallic map, the roughness map, and the height map based on the input digital material model. Based on a window of the bilinearly upsampled digital material model that corresponds to a given texel of the bilinearly upsampled digital material model, the upsampling system uses a Multilayer Perceptron (MLP) upsampler to reconstruct a high resolution value for a bilinearly upsampled texel, which is a set of digital material properties corresponding to a pixel of the digital material model. The upsampling system then applies the machine learning model to the bilinearly upsampled texel to generate a high resolution texel. The machine learning model is trained on the super-resolution digital material model, meaning the machine learning model is trained on the multiple upsampled versions of the radiances rendered from the digital material model under a set of different light positions.

Based on the high resolution texel, the upsampling system generates a high resolution digital material model. The high resolution digital material model results in a realistic-looking material when exposed to different light positions in the virtual environment. The upsampling module then generates an output including the high resolution digital material model for display in the user interface. For example, the high resolution digital material model is incorporated onto a three-dimensional virtual object, adding detailed virtual texture to the three-dimensional virtual object presented in the user interface.

Upsampling a digital material model based on radiances in this manner overcomes the disadvantages of conventional bilinear upsampling applications that do not account for different super-resolution radiances. For example, upsampling the digital material model based on radiances generates the high resolution texel, which also exhibits higher definition using the machine learning model trained on the multiple upsampled renderings of the input digital material model that correspond to the different light positions relative to the input digital material model. This results in the high resolution digital material model that behaves realistically when exposed to different lighting directions in the virtual environment, which is not possible using conventional bilinear upsampling applications that do not account for different super-resolution radiances.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

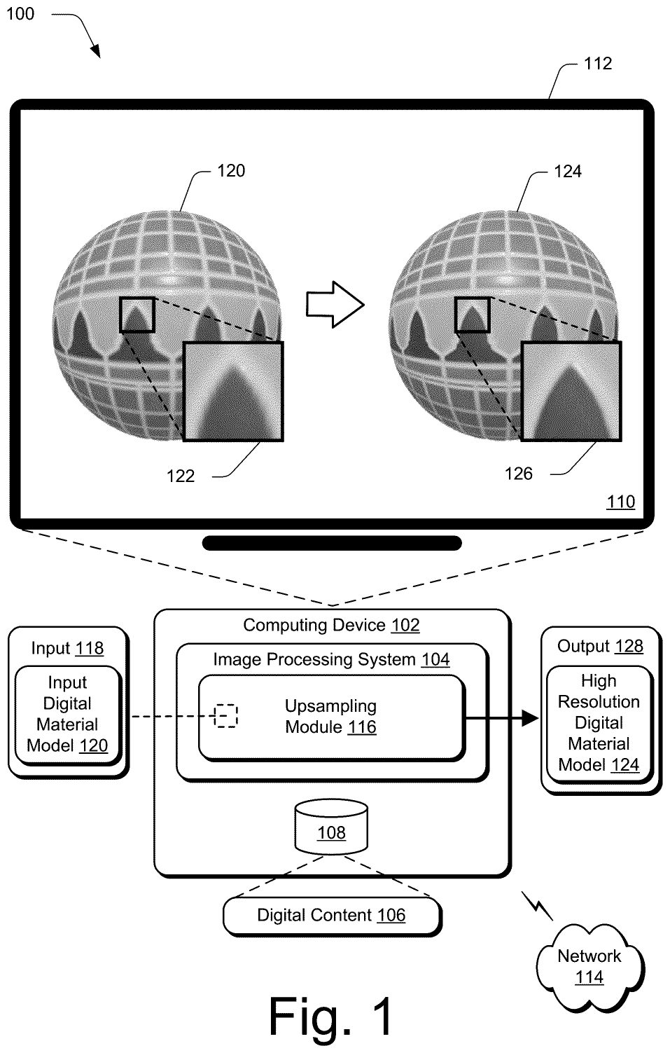

FIG. 1 is an illustration of a digital medium environment 100 in an example implementation that is operable to employ techniques and systems for upsampling a digital material model based on radiances described herein. The illustrated digital medium environment 100 includes a computing device 102, which is configurable in a variety of ways.

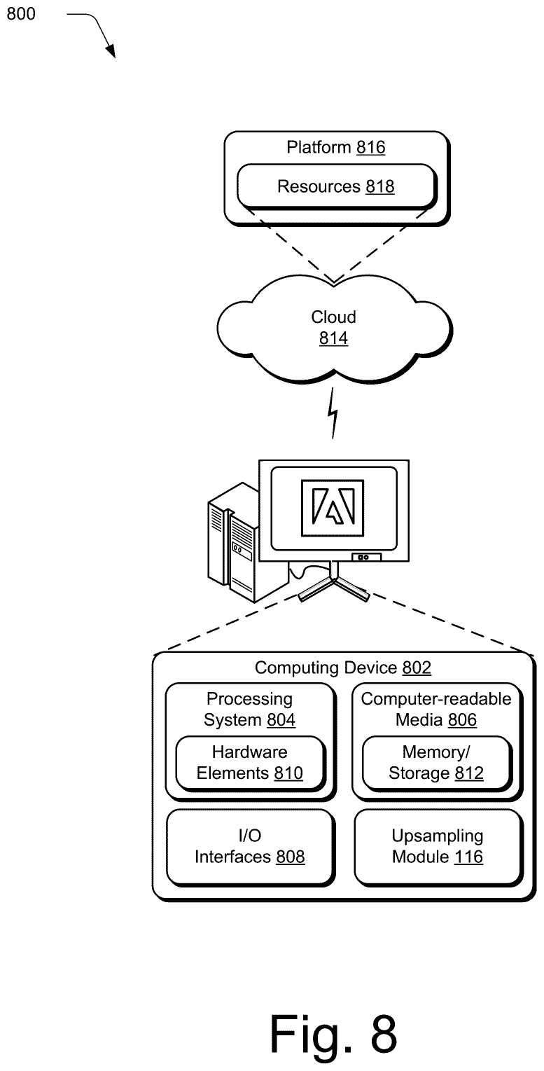

The computing device 102, for instance, is configurable as a desktop computer, a laptop computer, a mobile device (e.g., assuming a handheld configuration such as a tablet or mobile phone), an augmented reality device, and so forth. Thus, the computing device 102 ranges from full resource devices with substantial memory and processor resources (e.g., personal computers, game consoles) to a low-resource device with limited memory and/or processing resources, e.g., mobile devices. Additionally, although a single computing device 102 is shown, the computing device 102 is also representative of a plurality of different devices, such as multiple servers utilized by a business to perform operations “over the cloud” as described in FIG. 8.

The computing device 102 also includes an image processing system 104. The image processing system 104 is implemented at least partially in hardware of the computing device 102 to process and represent digital content 106, which is illustrated as maintained in storage 108 of the computing device 102. Such processing includes creation of the digital content 106, representation of the digital content 106, modification of the digital content 106, and rendering of the digital content 106 for display in a user interface 110 for output, e.g., by a display device 112. Although illustrated as implemented locally at the computing device 102, functionality of the image processing system 104 is also configurable entirely or partially via functionality available via the network 114, such as part of a web service or “in the cloud.”

The computing device 102 also includes an upsampling module 116 which is illustrated as incorporated by the image processing system 104 to process the digital content 106. In some examples, the upsampling module 116 is separate from the image processing system 104 such as in an example in which the upsampling module 116 is available via the network 114.

The upsampling module 116 is configured to receive an input 118 including an input digital material model 120 having a first resolution 122 and to generate a high resolution digital material model 124 having an updated resolution 126 that is higher than the first resolution 122. The input digital material model 120 is a collection of two-dimensional (2D) images that includes a visual appearance and properties of a three-dimensional (3D) surface or object rendered in a user interface 110. For example, the input digital material model 120 is intended to simulate attributes for a texture when applied to a surface of a 3D object, including base color, normal properties, metallicness, roughness, and height. Additionally or alternatively, the input digital material model 120 includes an embedding of another image that describes a property of a material. However, the input digital material model 120 in this example has a first resolution 122 that is a low resolution that does not result in realistic renderings when applied to the surface of the 3D object in the user interface 110.

To generate the high resolution digital material model 124 having the updated resolution 126 that is higher than the first resolution 122, the upsampling module 116 generates a super-resolution digital material model using a super-resolution algorithm based on super-resolution radiances corresponding to different light positions. For example, the super-resolution digital material model includes information related to multiple upsampled versions of the high resolution digital material model 124, each corresponding to a different light position relative to the high resolution digital material model 124.

The upsampling module 116 also generates a bilinearly upsampled texel. A texel is a base unit of the input digital material model 120, including a single pixel in some examples. The upsampling module 116 generates the bilinearly upsampled texel by increasing a size and resolution of the texel of the input digital material model 120.

The upsampling module 116 then generates a high resolution texel using a machine learning model. The machine learning model is trained on the super-resolution digital material model, meaning the machine learning model is trained on the multiple upsampled renderings that correspond to the different light positions relative to the input digital material model 120. Because of this, the high resolution texel is generated to mimic behavior relative to different light positions based on the upsampled radiances produced from renderings of the input digital material model 120 relative to the different light positions.

The upsampling module 116 then generates a high resolution digital material model 124 based on the high resolution texel. For example, multiple high resolution texels are generated using the machine learning model and are stitched together to generate the high resolution digital material model 124. The high resolution digital material model 124 results in a realistic-looking material when exposed to different light positions in the virtual environment.

The upsampling module 116 then generates an output 128 including the high resolution digital material model 124 for display in the user interface 110. For example, the high resolution digital material model 124 is incorporated onto a three-dimensional virtual object, adding detailed virtual texture to the three-dimensional virtual object presented in the user interface 110.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Upsampling a Digital Material Model Based on Radiances

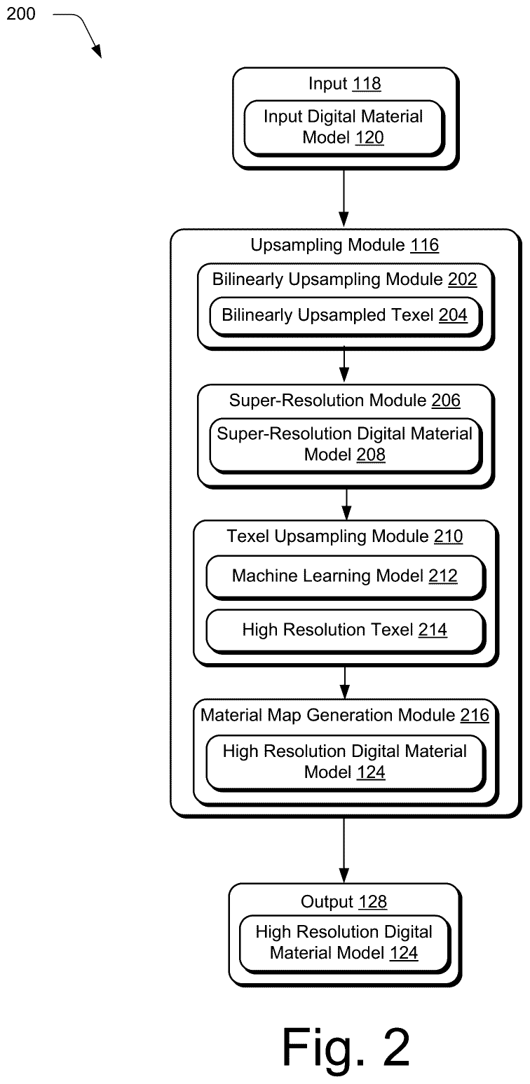

FIG. 2 depicts a system 200 in an example implementation showing operation of the upsampling module 116 of FIG. 1 in greater detail. The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks. In portions of the following discussion, reference is made to FIGS. 1-8.

To begin in this example, a upsampling module 116 receives an input digital material model 120. For example, the input digital material model 120 is a collection of 2D images used to define an appearance of a 3D object in 3D rendering. The input digital material model 120 is applied to a surface of a 3D model to provide details to simulate the appearance of real-world materials, including wood, metal, fabric, or stone, on a digital object. In this example, the input digital material model 120 is a compilation of maps including a base color map specifying base color, a normal map specifying normal properties, a metallic map specifying metallicness, a roughness map specifying roughness, and a height map specifying height. In an example, radiance images are generated during rendering using the input digital material model 120. The input digital material model 120 in this example has a first resolution 122 that is a low resolution that does not result in realistic radiances when applied to the surface of the 3D object in the user interface 110.

The upsampling module 116 also includes a bilinearly upsampling module 202. In this example, the bilinearly upsampling module 202 generates a bilinearly upsampled texel 204. To do this, the bilinearly upsampling module 202 operates on a texel-by-texel basis based on the input digital material model 120. A texel is a base unit of the input digital material model 120. For example, the bilinearly upsampling module 202 isolates a texel from the input digital material model 120 and generates the bilinearly upsampled texel by increasing a size and resolution of the texel.

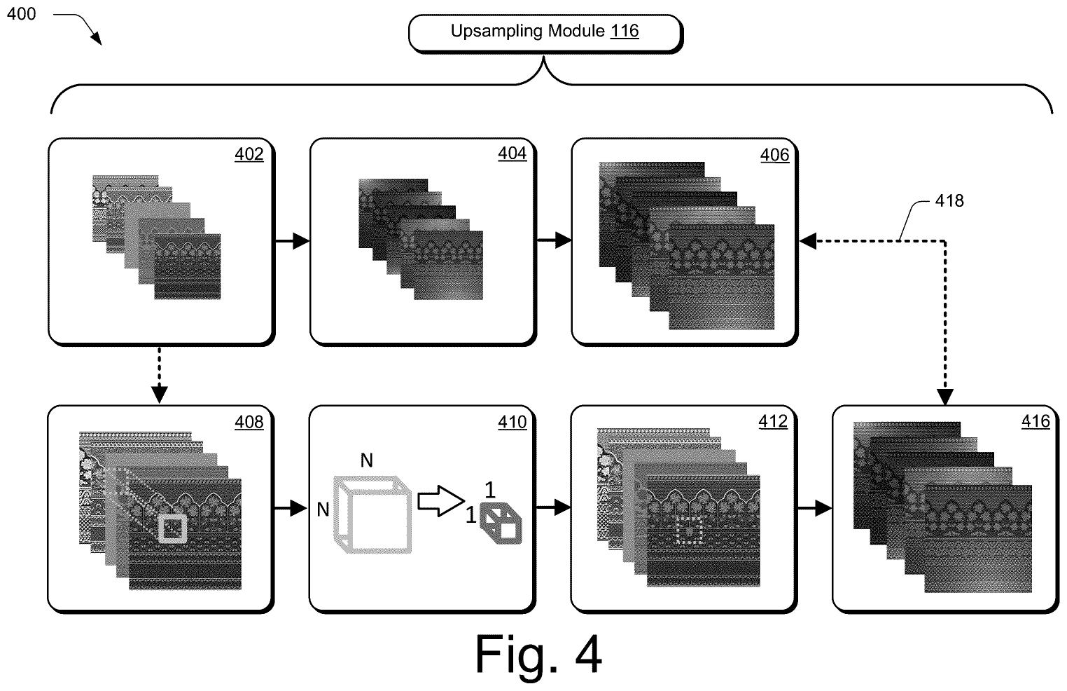

The upsampling module 116 also includes a super-resolution module 206. The super-resolution module 206 generates a super-resolution digital material model 208 using a super-resolution algorithm based on radiances corresponding to different light positions. The super-resolution algorithm generates a super-resolution digital material model 208 that has a higher level of resolution and a higher level of detail than the input digital material model 120. The super-resolution algorithm is described in detail with respect to FIG. 4. Additionally, the super-resolution digital material model 208 includes information related to multiple upsampled versions of the input digital material model 120, each corresponding to a different light position relative to the input digital material model 120. In other examples, the super-resolution module 206 generates the super-resolution digital material model 208 before the bilinearly upsampling module 202 generates the bilinearly upsampled texel 204.

The upsampling module 116 also includes a texel upsampling module 210. The texel upsampling module 210 uses a machine learning model 212 to generate a high resolution texel 214. The machine learning model 212 is trained on the super-resolution digital material model 208. Because of this, the machine learning model 212 is trained on the multiple upsampled versions of radiances that correspond to the different light positions relative to the input digital material model 120. The high resolution texel 214 is generated to display realistic behavior when exposed to different light positions based on behavior of the input digital material model 120 relative to the different light positions. In some examples, the high resolution texel 214 is generated using a transformer model including filters optimized for a series of radiances.

The upsampling module 116 also includes a digital material model generation module 216. The digital material model generation module 216 generates a high resolution digital material model 124 based on the high resolution texel 214. For example, multiple high resolution texels are generated using the machine learning model 212 and are incorporated into the high resolution digital material model 124. The high resolution digital material model 124 results in a realistic-looking material when exposed to different light positions in the virtual environment. The upsampling module 116 then generates an output 128 including the high resolution digital material model 124 for display in the user interface 110. For example, the high resolution digital material model 124 is incorporated onto a three-dimensional virtual object, adding detailed virtual texture to the three-dimensional virtual object presented in the user interface 110. In some examples, parameter optimization is performed on the high resolution digital material model 124.

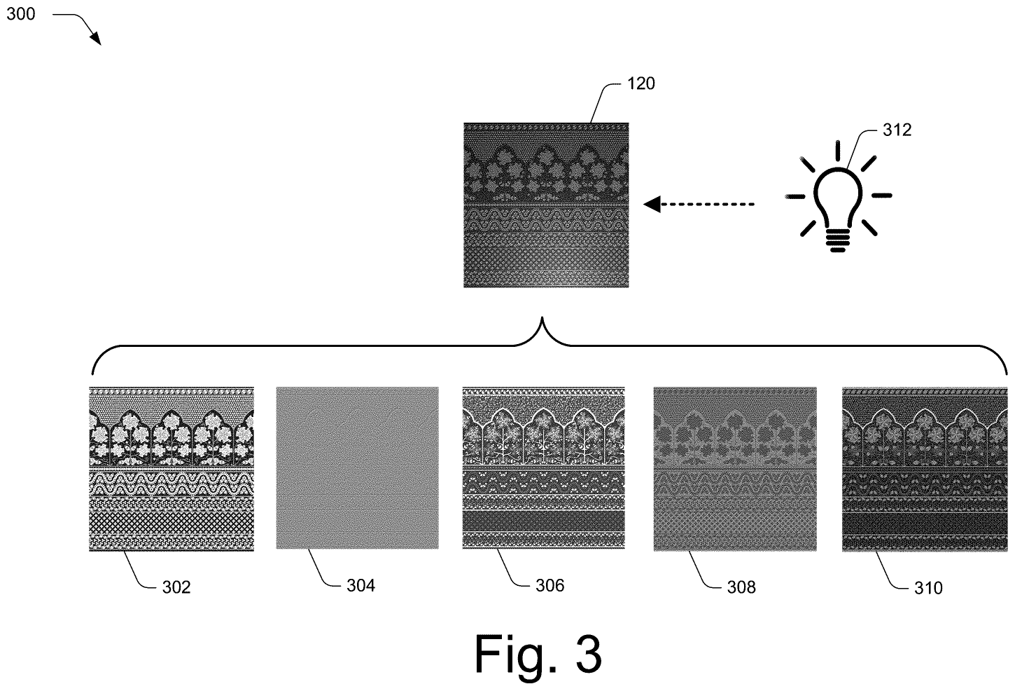

FIGS. 3-5 depict stages of upsampling a digital material model based on radiances. In some examples, the stages depicted in these figures are performed in a different order than described below.

FIG. 3 depicts an example 300 of an input digital material model 120. The input digital material model 120 is a 2D image that defines visual properties of a 3D object's surface. The input digital material model 120 provides information about the object's color, reflectivity, transparency, roughness, and other surface characteristics. A digital material model is applied to a corresponding 3D model by mapping pixels of the 2D image onto the surface of the 3D object. This process is called “UV mapping,” where UV coordinates are assigned to each vertex of the 3D model and determine how the digital material model wraps around the 3D object's surface.

The input digital material model 120 includes multiple digital material models that define a specific property, including a base color map, a normal map, a metallic map, a roughness map, and a height map. The base color map defines the color and overall appearance of the surface and specifies the base color or texture applied to the 3D object. The normal map encodes information about surface normals of the 3D object. Each pixel in the normal map represents a perturbation of the surface normal, which gives the illusion of fine details and surface bumps without actually modifying the geometry. The metallic map specifies reflection highlights on the surface of the 3D object, indicating the areas that are more or less reflective to create a visual illusion of shininess or glossiness. The roughness map simulates surface detail. Instead of storing surface normals, the roughness map encodes height information in grayscale values, creating a visual illusion of bumps and depressions on the surface of the 3D object. The height map modifies the geometry of the 3D object by displacing vertices of the 3D object based on the values of the map. The height map adds additional depth and detail to the surface, creating a visual illusion of height variations.

The input digital material model 120 also stores information related to how light interacts with the surface of the 3D object. Different channels of the input digital material model 120 represent aspects of light interaction, including as reflection, refraction, transparency, and roughness. For example, different lighting positions in relation to the input digital material model 120 result in different levels and locations of reflection, glare, shininess, shadows, and highlights on the input digital material model 120, and the information related to these interactions is stored in the input digital material model 120.

In this example, the input digital material model 120 features a pattern designed by a user to apply to a surface of a 3D object. For instance, the input digital material model 120 includes a base color map 302, a normal map 304, a metallic map 306, a roughness map 308, and a height map 310.

FIG. 4 depicts an example 400 of an architecture of the upsampling module 116. FIG. 4 is a continuation of the example described in FIG. 3.

At step 402, the upsampling module 116 receives the input digital material model 120, which includes a base color map, a normal map, a metallic map, a roughness map, and a height map, as described with respect to FIG. 3. For example, the input includes a set of low-resolution (LR) spatially-varying bidirectional reflectance distribution (SVBRDF) maps M_{LR} having a size of 128 pixels squared.

At step 404, the upsampling module 116 renders multiple images representing different radiances of the input digital material model 120. A radiance corresponds to a specific light position relative to the input digital material model 120. To do this, the upsampling module 116 uses a shading model R applied to the low-resolution inputs R (M_{LR}). For example, the upsampling module 116 recovers SVBRDF parameters for the underlying high-resolution SVBRDF M_{SR}, including the base color map, the normal map, the metallic map, the roughness map, and the height map.

At step 406, the super-resolution module 206 generates a super-resolution digital material model 208 for each image of the multiple images representing the different radiances of the input digital material model 120. The super-resolution module 206 uses an RGB upsampler or other natural image upsampler to obtain the super-resolution digital material model 208 for each radiance, having a size of 512 pixels squared. The RGB upsampler is an algorithm used to increase the resolution of an image that is represented in the RGB (Red, Green, and Blue) color format. The upsampling process involves analyzing existing RGB pixel values and generating new pixels based on the surrounding information. The super-resolution digital material model 208 is used to train the machine learning model 212, as described in detail below. In some examples, the super-resolution algorithm is a SwinIR (Liang et al. 2021) or a SRFlow (Lugmayr et al. 2020). For SwinIR, learned weights of the large model SwinIRL_x4_GAN are trained for real-world images. For SRFlow, SRFlow_DF2K_4X trained weights are used.

At step 408, the bilinearly upsampling module 202 generates a bilinearly upsampled texel 204. To do this, the bilinearly upsampling module 202 first generates a bilinearly upsampled digital material model that includes bilinearly upsampled versions of the base color map, the normal map, the metallic map, the roughness map, and the height map based on the input digital material model 120.

At step 410, the bilinearly upsampling module 202 identifies a window of size N×N that corresponds to a given texel of the bilinearly upsampled digital material model. The window includes a channel corresponding to the base color map, the normal map, the metallic map, the roughness map, and the height map that are connected as an input to a Multilayer Perceptron (MLP). The MLP generates a bilinearly upsampled texel 204, which is a set of digital material models corresponding to a 1×1 pixel.

At step 412, the texel upsampling module 210 uses a machine learning model 212 to generate a high resolution texel 214. The machine learning model 212 is trained on the super-resolution digital material model 208, meaning the machine learning model 212 is trained on the multiple upsampled versions of the input digital material model 120 that correspond to the different light positions relative to the input digital material model 120. The high resolution texel 214 is generated to display realistic behavior when exposed to different light positions based on behavior of the input digital material model 120 relative to the different light positions.

At step 416, the digital material model generation module 216 generates a high resolution digital material model 124 based on the high resolution texel 214. For example, multiple high resolution texels are generated using the machine learning model 212 and are incorporated into the high resolution digital material model 124. The high resolution digital material model 124 results in a realistic-looking material when exposed to different light positions in the virtual environment. The upsampling module 116 then generates an output 128 including the high resolution digital material model 124 for display in the user interface 110. For example, the high resolution digital material model 124 is incorporated onto a three-dimensional virtual object, adding detailed virtual texture to the three-dimensional virtual object presented in the user interface 110.

Intermediary step 418 represents loss function training. Weights are trained so that the high resolution digital material model 124 matches how the light interacts with the super-resolution digital material model 208.

Here, the loss function for a given pixel p is:

$$ℒ ( p ) = {\underbrace{{\sum }_{{ω}_{i} ∈ Ω} {‖ {R}_{SR} ( {M}_{LR} ) ( p ) - R ( {M}_{SR} ) ( p ) ‖}_{2}}}_{:= {ℒ}_{fit} ( p )} + {ℒ}_{reg}^{2} ( p )$$

where ∥(r̅, g̅, b̅)−(r, g, b)∥₂:=\sqrt{(r̅−r)²+(g̅−g)²+(b̅−b)²}, Ω is a set of selected light source directions ω₂, and [symbol] _{reg} is a regularization loss.

Given a collection of texels P={p} (many pixels of one or multiple materials), the respective loss functions { [symbol] (p)} pep are collectively minimized. While the upscaled renderings primarily exhibit common structures, outliers appear. To address the outliers, a 2-level fitting strategy is applied to output a clean SVBRDF at the pixel level and at the material level. At the pixel level, a sparsity-inducing loss is used that allows retaining a pertinent BRDF signal, even in the presence of such outliers, as described in detail below. At the material level, a function mapping the input to the output is collaboratively optimized for consistent upsampling of similar regions.

Regarding sparsity-inducing loss, given P, the following loss is minimized:

$$ℒ = {\sum }_{p ∈ P} ℒ ( p ) = {\underbrace{{\sum }_{p ∈ P} {ℒ}_{fit} ( p )}}_{:= {ℒ}_{fit}} + {\underbrace{{\sum }_{p ∈ P} {ℒ}_{reg}^{2} ( p )}}_{:= {ℒ}_{reg}^{2}}$$

where [symbol] is the sum of a l₁ norm over all data-fitting terms in P and a l₂ squared norm over all regularization terms in P:

[symbol]

_{fit}=∥{ [symbol] _{fit}(p)}_{p∈P}∥₁//sparsity-inducing data fitting

[symbol]

_{reg}=∥{ [symbol] _{reg}(p)}_{p∈P}∥₁//structural regularization prior

Regarding MLP-based optimization, each texel p of the high-resolution maps M_{SR}(p) is computed using a Multilayer Perceptron (MLP) with entries that are a square window of size N×N centered in p of the input material upsampled bilinearly M_{LR}^{↑↑}. The MLP computes a difference to the center texel. The machine learning model 212 then learns filters that take as input the bilinearly upsampled digital material model and outputs a super-resolution texel, the filters optimized for a specific pair of shading model R and radiance upsampler S.

Regarding Height map reconstruction, geometric mesostructures are captured by the normal map, onto which a height map is reconstructed following Martin et al. [2022]. A normal integration scheme is applied [Durou and Courteille 2007], which uses a Poisson solve. The low-resolution input height map provides a dense anchor to combat low-frequency noise, as described by Nehab et al. [2005], by compositing a high-pass filtering of the upsampled normal-based height channel with a bilinear upsampling of the input.

Regarding SVBRDF parameter regularization, the metallic map encodes values that diverge from its original low-resolution counterpart during optimization. To prevent further deviation from the original values, a regularization term is applied:

$${ℒ}_{reg}^{2} ( p ) = α \cdot {( {m}_{LR}^{↑ ↑} ( p ) - {m}_{SR} ( p ) )}^{2}$$

where α is a weighting parameter, m_{LR}^{↑↑} denotes a bilinear upsampling of the low-resolution metallic map m_{LR}, and m_{SR} is the optimized metallic map. This produces values that mimic the original metallic map while remaining sharper than the bilinearly upsampled input.

Conventional per-pixel optimization suffers from performance issues because existing RGB supersamplers make it difficult to process large inputs (e.g. 4096×4096 pixels), and such inputs cannot be optimized concurrently by this approach because of the high amount of VRAM required during gradient descent. For this reason, a tile-based strategy is used to decompose materials into small tiles (of size 128×128 pixels in this example) for processing. This results in noisy output maps and visible seams between adjacent tiles. Independently of the tile-based decomposition, materials showcasing self-similarities are treated consistently by the optimization. However, independently optimizing texels leads to self-similar patches that provide inconsistent results, where similar colored structures tend to result in either smooth or sharp visual transitions.

A fully-connected MLP is used to achieve spatial regularization. The fully-connected MLP takes as input a small texel patch in the bilinearly upsampled low-resolution SVBRDF M_{LR}^{↑↑} and outputs a single texel of the high-resolution SVBRDF M_{SR}. The SVBRDF is then provided to the differentiable renderer and used to compute the loss [symbol] of the sparsity-inducing loss.

To generate data to train the machine learning model 212, the upsampling module 116 takes as input 128×128 pixels of low-resolution SVBRDFs and computes multiple renderings under varying point light positions. In some examples, the renderings are sampled from a Fibonacci set to uniformly cover a hemisphere. For rendering, a standard microfacet model [Cook and Torrance 1982] is implemented with a GGX [Trowbridge and Reitz 1975; Walter et al. 2007] normal distribution function in PyTorch, omitting the energy falloff to preserve information for the upsamplers. Two different super-resolution algorithms are applied, as described above with reference to the super-resolution module 206. This provides a pair of low-resolution SVBRDF and high-resolution renderings for training the SVBRDF upsampling network.

The MLP consists in 6 fully-connected hidden layers of size 512, which take as input a 17×17 tile of texels. In this example, the loss function, described above, uses α=10⁻¹. The weights of the machine learning model 212 are optimized using gradient descent with the Adam optimizer with default parameters.

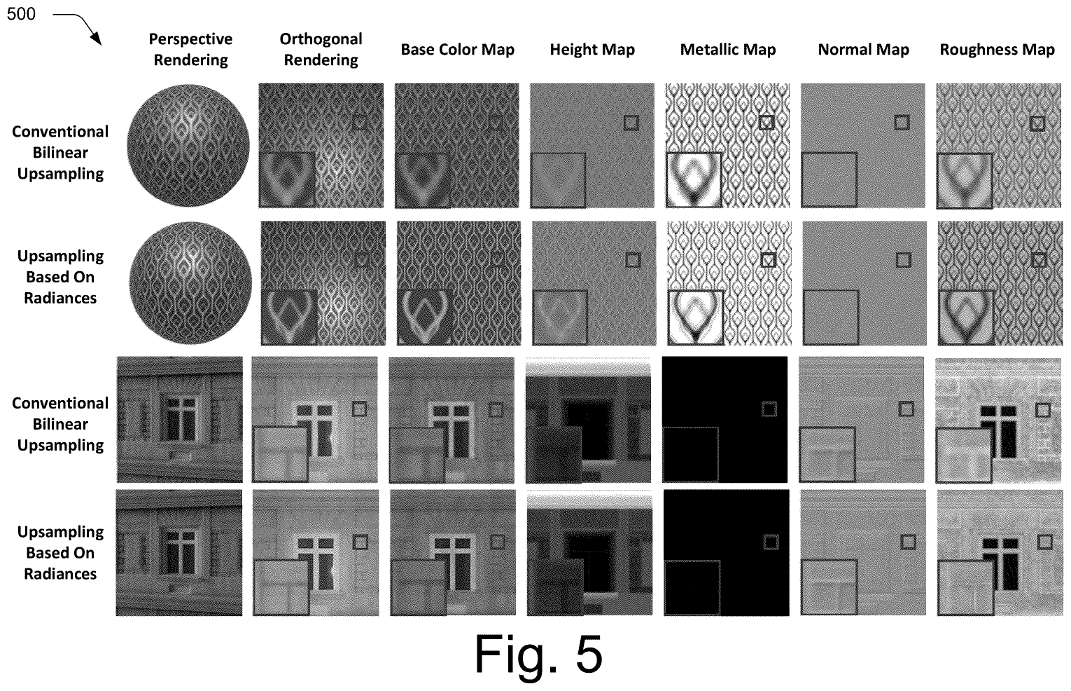

FIG. 5 depicts an example 500 including a table of outputs including different high resolution digital material models. For example, the upsampling module 116 generates an output 128 including the high resolution digital material model 124 for display in the user interface 110. In this example, the Orthogonal Renderings illustrate the high resolution digital material models. The Perspective Renderings illustrate the high resolution digital material models applied to a 3D geometry. For example, the high resolution digital material model 124 is incorporated onto a three-dimensional virtual object, adding detailed virtual texture to the three-dimensional virtual object presented in the user interface 110. As illustrated, upsampling based on radiances results in digital material models that have a higher level of detail than digital material models generated using conventional bilinear upsampling.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-5.

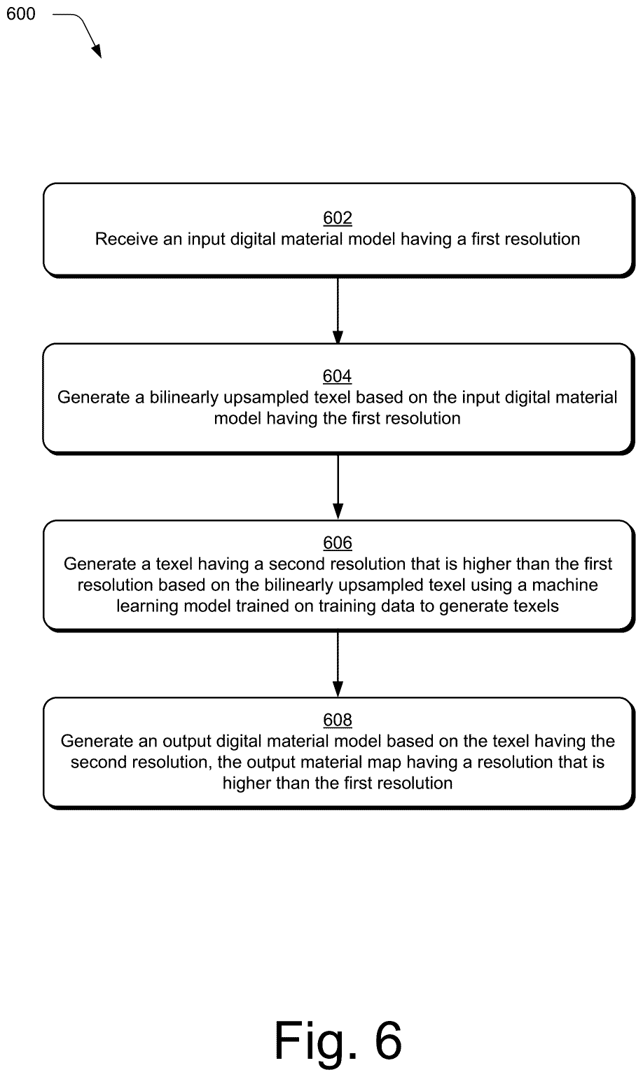

FIG. 6 depicts a procedure 600 in an example implementation of upsampling a digital material model based on radiances. At block 602, an input digital material model 120 having a first resolution is received. In some examples, the input digital material model 120 having the first resolution includes at least one of a base color map 302, a normal map 304, a metallic map 306, a roughness map 308, or a height map 310.

At block 604, a bilinearly upsampled texel 204 is generated based on the input digital material model 120 having the first resolution.

At block 606, a texel having a second resolution that is higher than the first resolution is generated based on the bilinearly upsampled texel 204 using a machine learning model 212 trained on training data to generate texels. In some examples, the training data includes renderings computed from texels upsampled by an image upsampler at different light positions. For example, the renderings are generated using a microfacet model. Additionally or alternatively, the machine learning model 212 includes a multilayer perceptron model. In some examples, the texel having the second resolution is generated by a transformer model. Additionally or alternatively, the transformer model includes filters optimized for a series of radiances.

At block 608, an output digital material model is generated based on the texel having the second resolution, the output digital material model having a resolution that is higher than the first resolution. Some examples further comprise performing parameter optimization on the output digital material model. Additionally or alternatively, the output digital material model is applied to a three-dimensional geometry.

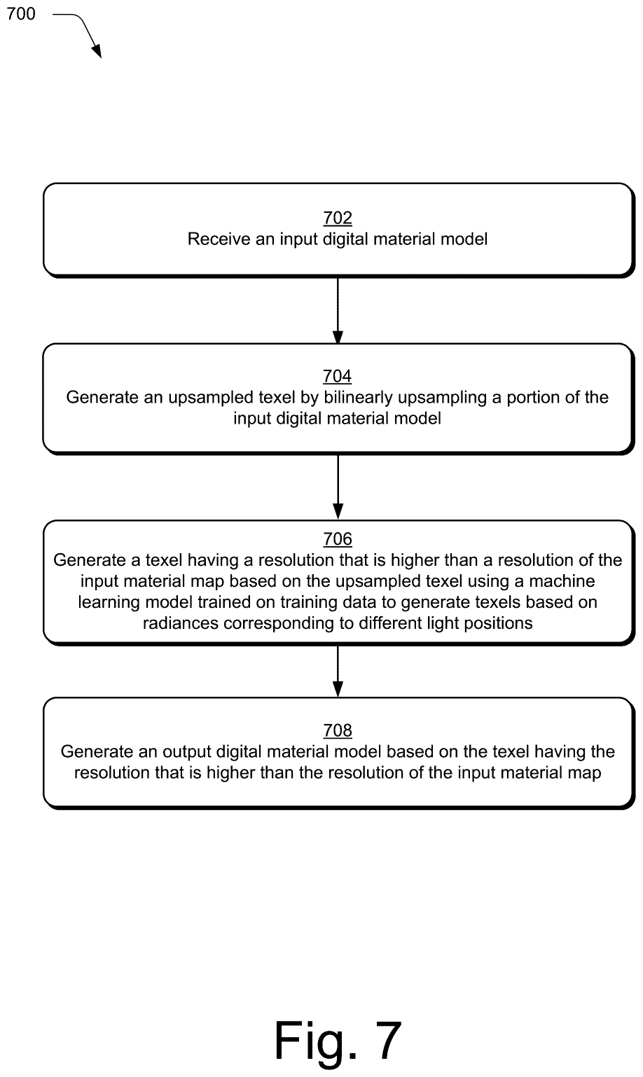

FIG. 7 depicts a procedure 700 in an additional example implementation of upsampling a digital material model based on radiances. At block 702, an input digital material model 120 is received. In some examples, the input digital material model 120 includes at least one of a base color map 302, a normal map 304, a metallic map 306, a roughness map 308, or a height map 310.

At block 704, an upsampled texel is generated by bilinearly upsampling a portion of the input digital material model 120.

At block 706, a texel is generated having a resolution that is higher than a resolution of the input digital material model 120 based on the upsampled texel using a machine learning model 212 trained on training data to generate texels based on radiances corresponding to different light positions. In some examples, the training data includes renderings computed from texels upsampled by an image upsampler at different light positions. In some examples, the machine learning model is a multilayer perceptron model. Additionally or alternatively, the texel is generated by a transformer model. For example, the transformer model includes filters optimized for a series of radiances.

At block 708, an output digital material model is generated based on the texel having the resolution that is higher than the resolution of the input digital material model 120. Some examples further comprise performing parameter optimization on the output digital material model.

### Example System and Device

FIG. 8 illustrates an example system generally at 800 that includes an example computing device 802 that is representative of one or more computing systems and/or devices that implement the various techniques described herein. This is illustrated through inclusion of the upsampling module 116. The computing device 802 is configurable, for example, as a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 806 is illustrated as including memory/storage 812. The memory/storage 812 represents memory/storage capacity associated with one or more computer-readable media. The memory/storage 812 includes volatile media (such as random access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (for example, one or more computing devices and/or processing systems 804) to implement techniques, modules, and examples described herein.

The techniques described herein are supported by various configurations of the computing device 802 and are not limited to the specific examples of the techniques described herein. This functionality is also implementable through use of a distributed system, such as over a “cloud” 1114 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized when computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

What is claimed is:

1. A method comprising:
receiving, by a processing device, an input digital material model having a first resolution;
generating, by the processing device, a bilinearly upsampled texel based on the input digital material model having the first resolution;
generating, by the processing device, a texel having a second resolution that is higher than the first resolution based on the bilinearly upsampled texel using a machine learning model trained on training data to generate texels; and
generating, by the processing device for display in a user interface, an output digital material model based on the texel having the second resolution, the output digital material model having a resolution that is higher than the first resolution.

2. The method of claim 1, wherein the training data includes renderings computed from texels upsampled by an image upsampler at different light positions.

3. The method of claim 2, wherein the renderings are generated using a microfacet model.

4. The method of claim 1, wherein the input digital material model having the first resolution includes at least one of a base color map, a normal map, a metallic map, a roughness map, or a height map.

5. The method of claim 1, wherein the machine learning model includes a multilayer perceptron model.

6. The method of claim 1, wherein the texel having the second resolution is generated by a transformer model.

7. The method of claim 6, wherein the transformer model includes filters optimized for a series of radiances.

8. The method of claim 1, further comprising performing parameter optimization on the output digital material model.

9. The method of claim 1, wherein the output digital material model is applied to a three-dimensional geometry.

10. A system comprising:
a memory component; and
a processing device coupled to the memory component, the processing device to perform operations comprising:
receiving an input digital material model;
generating an upsampled texel by bilinearly upsampling a portion of the input digital material model;
generating a texel having a resolution that is higher than a resolution of the input digital material model based on the upsampled texel using a machine learning model trained on training data to generate texels based on radiances corresponding to different light positions; and
generating an output digital material model based on the texel having the resolution that is higher than the resolution of the input digital material model.

11. The system of claim 10, wherein the training data includes renderings computed from texels upsampled by an image upsampler at different light positions.

12. The system of claim 10, wherein the input digital material model includes at least one of a base color map, a normal map, a metallic map, a roughness map, or a height map.

13. The system of claim 10, wherein the machine learning model is a multilayer perceptron model.

14. The system of claim 10, wherein the texel is generated by a transformer model.

15. The system of claim 14, wherein the transformer model includes filters optimized for a series of radiances.

16. The system of claim 10, further comprising performing parameter optimization on the output digital material model.

17. A non-transitory computer-readable storage medium storing executable instructions, which when executed by a processing device, cause the processing device to perform operations comprising:
receiving an input digital material model having a first resolution;
generating a bilinearly upsampled texel based on the input digital material model having the first resolution;
generating a texel having a second resolution that is higher than the first resolution based on the bilinearly upsampled texel using a machine learning model trained on training data to generate texels; and
generating, for display in a user interface, an output digital material model based on the texel having the second resolution, the output digital material model having a resolution that is higher than the first resolution.

18. The non-transitory computer-readable storage medium of claim 17, wherein the training data includes renderings computed from texels upsampled by an image upsampler at different light positions.

19. The non-transitory computer-readable storage medium of claim 18, wherein the renderings are generated using a microfacet model.

20. The non-transitory computer-readable storage medium of claim 17, wherein the input digital material model having the first resolution includes at least one of a base color map, a normal map, a metallic map, a roughness map, or a height map.
